(19) United States
(12) Patent Application Publication
(10) Pub. No.: US 2022/0269313 A1
(43) Pub. Date: Aug. 25, 2022

(54) ELECTRONIC APPARATUS

(71) Applicant: LENOVO (SINGAPORE) PTE. LTD., SINGAPORE (SG)

(72) Inventors: Kenji Watamura, YOKOHAMA (JP); Moriyuki Tsuchihashi, YOKOHAMA (JP); Yuichi Onda, YOKOHAMA (JP)

(73) Assignee: LENOVO (SINGAPORE) PTE. LTD., SINGAPORE (SG)

(21) Appl. No.: 17/645,329

(22) Filed: Dec. 21, 2021

(30) Foreign Application Priority Data
Feb. 25, 2021 (JP) 202128864

(51) Int. Cl. G06F 1/16

(52) U.S. Cl. CPC G06F 1/1662; G06F 1/169

(57) ABSTRACT

A computing device includes a chassis with a keyboard surface, a click pad mounted on the keyboard surface including a touch operation surface, and a light emitting device mounted in the chassis, the light emitting device being configured to emit light toward a transmission window provided on the keyboard surface adjacent to the click pad. The light emitting device includes a light emitter disposed under the click pad, a light guide extending along the touch operation surface under the click pad and configured to guide light from the light emitter, and a light diffusion member disposed adjacent to the click pad under the transmission window, the light diffusion member being configured to diffuse light emitted from the emission surface through the transmission window.

### TECHNICAL FIELD

The present disclosure relates to an electronic apparatus that includes a light emitting device.

### BACKGROUND

The demand for a reduction in thickness of electronic apparatuses such as a laptop PC and a tablet PC is high. Therefore, an input operation portion, such as a touchpad or push buttons, that allows click input is desirably designed to eliminate its mechanical up-and-down movement.

### SUMMARY

In one aspect, a computing device includes a chassis with a keyboard surface, a click pad mounted on the keyboard surface including a touch operation surface, and a light emitting device mounted in the chassis, the light emitting device being configured to emit light toward a transmission window provided on the keyboard surface adjacent to the click pad. The light emitting device includes a light emitter disposed under the click pad, a light guide extending along the touch operation surface under the click pad and configured to guide light from the light emitter, and a light diffusion member disposed adjacent to the click pad under the transmission window, the light diffusion member being configured to diffuse light emitted from the emission surface through the transmission window.

### BRIEF DESCRIPTION OF THE DRAWINGS

FIG. 1 is a perspective view of an electronic apparatus;

FIG. 2 is a perspective view in the state where the electronic apparatus is in a 0-degree posture with a first chassis and a second chassis closed;

FIG. 3A is a plan view schematically illustrating the configuration of a transmission window and its peripheral portion in the state where a light emitting device is not emitting light;

FIG. 3B is a plan view schematically illustrating the configuration of the transmission window and its peripheral portion in the state where the light emitting device is emitting light;

FIG. 4 is a perspective view in which the light emitting device and its peripheral portion are viewed from above in the state where the transmission window is omitted;

FIG. 5 is a perspective view in which the light emitting device and its peripheral portion are viewed from above in the state where part of a plate portion is cut by a horizontal plane along the front-rear direction and the left-right direction;

FIG. 6 is an exploded perspective view in which the light emitting device and its peripheral portion are viewed from below; and

FIG. 7 is a schematic side sectional view in which the first chassis is cut by a vertical plane along the front-rear direction and the top-bottom direction at a position passing through the light emitting device.

### DETAILED DESCRIPTION

Hereinafter, a preferred embodiment of an electronic apparatus according to the present disclosure will be described in detail with reference to the accompanying drawings.

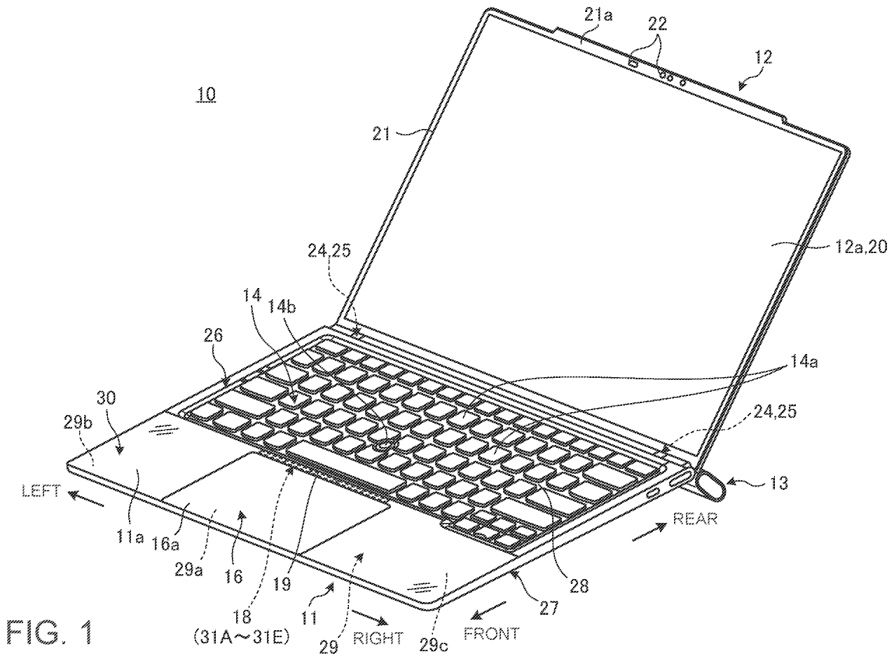

FIG. 1 is a perspective view of an electronic apparatus 10 according to an embodiment. As illustrated in FIG. 1, the electronic apparatus 10 includes a first chassis 11, a second chassis 12, and a third chassis 13. The second chassis 12 and the third chassis 13 are each coupled to the first chassis 11 so as to be pivotable relative to the first chassis 11. The electronic apparatus 10 is configured such that the first chassis 11 and the second chassis 12 form the external appearance of a general clamshell laptop PC and that the third chassis 13 serves as both a device housing portion and a stand of such a laptop PC.

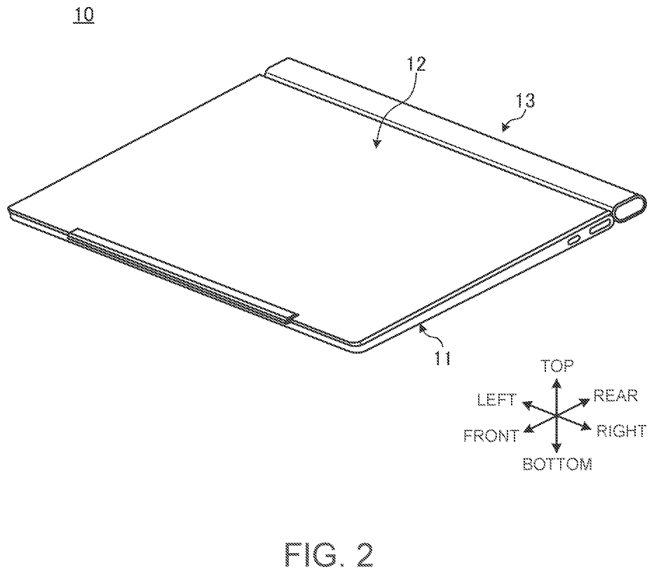

FIG. 2 is a perspective view in the state where the electronic apparatus 10 is in a 0-degree posture with the first chassis 11 and the second chassis 12 closed. Hereinafter, unless otherwise stated, the electronic apparatus 10 will be described by referring to the depth direction of the chassis 11 to 13 in the 0-degree posture illustrated in FIG. 2, as front-rear, the width direction thereof as left-right, and the thickness direction thereof as top-bottom. These directions are defined for convenience of description. The actual directions change according to a posture of the electronic apparatus 10 when used or stored, or change according to a direction of viewing the electronic apparatus 10.

First, the overall configuration of each of the chassis 11 to 13 will be described.

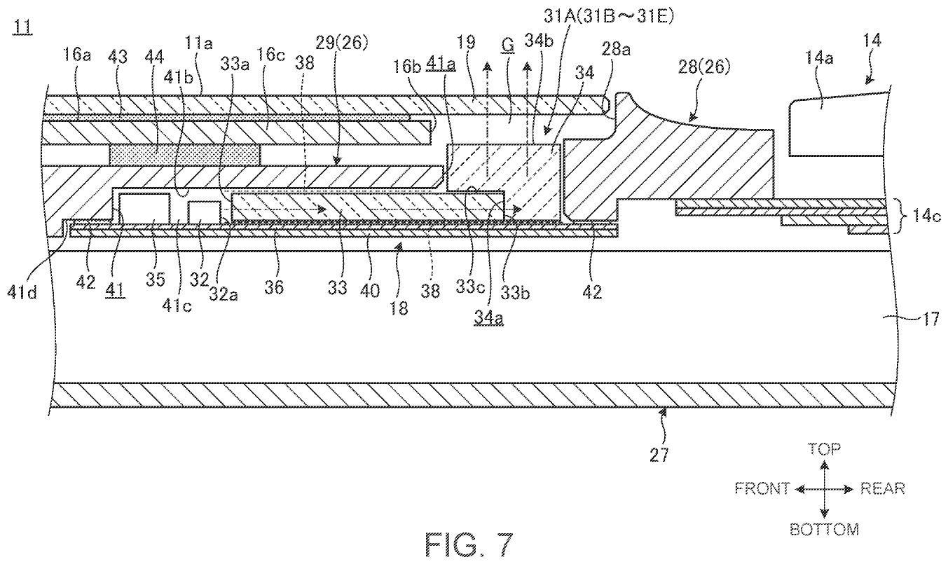

The first chassis 11 is a thin box-shaped chassis. A keyboard device 14 with an array of a plurality of key tops 14a and a touchpad input device 16 are exposed on a surface 11a (a top surface in the 0-degree posture) of the first chassis 11. The keyboard device 14 may alternatively be configured such that a touch panel display is provided on the surface 11a and that a software keyboard device is displayed on the touch panel display. A motherboard mounted with a CPU and a memory, a battery device 17, and so on are housed inside the first chassis 11 (see FIG. 7).

The first chassis 11 is equipped with a light emitting device 18 (see FIG. 7). The light emitting device 18 is a device that is configured to emit light through a transmission window 19 provided to the surface 11a. It should be noted that a light emitting device that can ensure sufficient brightness and visibility tends to be thick due to the length of a light guide member and so on. On the other hand, there is a problem that since the demand for a reduction in thickness of a chassis of the electronic apparatus described is strong, it is difficult to ensure a sufficient space in the thickness direction of the chassis. As such, the light emitting device 18 is desirably designed with reduced thickness while ensuring sufficient light brightness. The detailed configuration of the light emitting device 18 will be described later.

The second chassis 12 is a box-shaped chassis thinner than the first chassis 11. A display 20 is exposed on a surface 12a (a bottom surface in the 0-degree posture) of the second chassis 12. The display 20 is a liquid crystal display or an organic EL display, for example. The display 20 is surrounded by a frame-shaped bezel 21. Subdevices 22 such as a camera and a microphone are mounted on a portion (a top bezel 21a) that is located on the top side in an angle posture illustrated in FIG. 1. The bezel 21 may also be used for a cover glass covering the surface 12a of the second chassis 12. The second chassis 12 is coupled to the first chassis 11 via first hinges 24 so as to be relatively pivotable.

The third chassis 13 is a box-shaped chassis thicker than each of the chassis 11, 12 and shorter than each of the chassis 11, 12 in the front-rear direction. The thickness of the third chassis 13 is, for example, approximately equal to the sum of the thicknesses of the chassis 11, 12 (see FIG. 2). In the 0-degree posture in which the chassis 11, 12 are stacked one on top of the other, the third chassis 13 is in a posture protruding rearward from rear end portions of the chassis 11, 12. The third chassis 13 mainly has two functions. The first function is a function as a device housing portion for housing a control board configured to control display of the display 20, a speaker, an antenna, and so on. The second function is a function as a stand when opening the second chassis 12 from the first chassis 11 to use the electronic apparatus 10. The third chassis 13 is coupled to the first chassis 11 via second hinges 25 so as to be relatively pivotable.

The electronic apparatus 10 is configured such that the second chassis 12 can be pivoted with respect to the first chassis 11 from the 0-degree posture (see FIG. 2), via the 135-degree posture (see FIG. 1), to the 180-degree posture at maximum. In this event, the third chassis 13 is pushed by the second chassis 12 so as to pivot with respect to the first chassis 11. The electronic apparatus 10 may alternatively be a general clamshell laptop PC that does not have the third chassis 13 and in which the first chassis 11 and the second chassis 12 are coupled together by hinges so as to be relatively pivotable. The electronic apparatus 10 may be, other than a laptop PC, a tablet PC, a smartphone, or a portable game console, for example, and thus may have a configuration that does not have the plurality of the chassis 11 to 13.

Next, the configuration of the light emitting device 18 and its peripheral portion will be described.

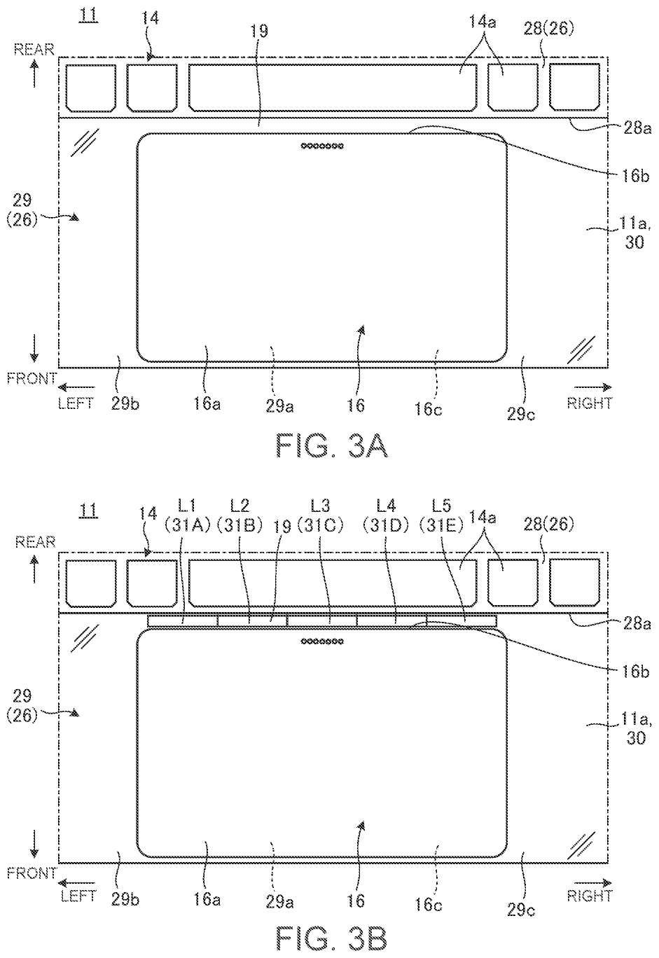

First, a light emitting state at the surface 11a of the first chassis 11 by the light emitting device 18 will be described. FIG. 3A is a plan view schematically illustrating the configuration of the transmission window 19 and its peripheral portion in the state where the light emitting device 18 is not emitting light. FIG. 3B is a plan view schematically illustrating the configuration of the transmission window 19 and its peripheral portion in the state where the light emitting device 18 is emitting light.

As illustrated in FIG. 1, the first chassis 11 is constituted by a top cover member 26 and a bottom cover member 27. The top cover member 26 forms the surface 11a and four peripheral side surfaces. The bottom cover member forms a bottom surface. The cover members 26, 27 are made of metal, resin, carbon fiber reinforced resin, or the like. The top cover member 26 is constituted by a frame portion 28 on the rear side and a plate portion 29 on the front side.

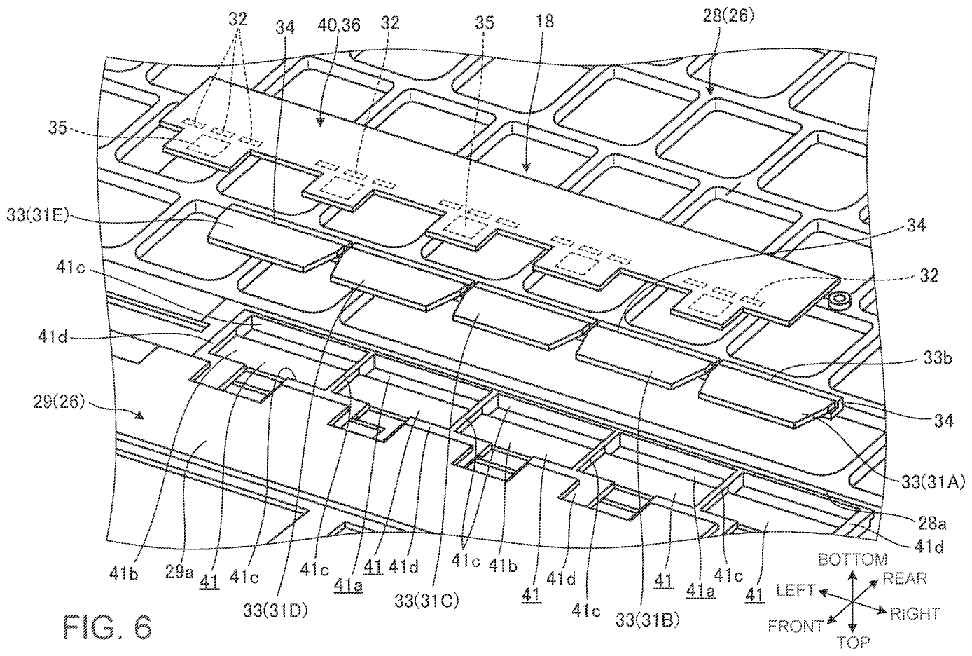

The frame portion 28 forms a region, including the keyboard device 14, of the surface 11a of the first chassis 11. The frame portion 28 is mostly formed in a mesh pattern (see FIG. 6), and the keyboard device 14 is attached from below. Each of the key tops 14a is individually inserted into a corresponding one of meshes of the frame portion 28. That is, the frame portion 28 is an isolation frame that partitions each of the key tops 14a.

The plate portion 29 forms a portion, forward of the keyboard device 14, of the surface 11a of the first chassis 11. In the plate portion 29, the input device 16 is attached from above to a central portion 29a that is one step lower than the other portions of the plate portion 29, and a left side portion 29b and a right side portion 29c each serve as a palm rest. Almost the entire surface of a top surface of the plate portion 29 is covered with a glass plate 30. The glass plate 30 is a rectangular plate extending over almost the entire width of the first chassis 11 in the left-right direction. That is, it can also be said that the surface 11a of the first chassis 11 is formed by the glass plate 30 at a portion forward of the keyboard device 14. The glass plate 30 may also cover the peripheral portions of the keyboard device 14 of the frame portion 28, for example. Alternatively, the glass plate 30 may be omitted.

As illustrated in FIGS. 3A and 3B, the transmission window 19 is formed by a part of the glass plate 30. The glass plate 30 protrudes rearward of a rear edge portion 16b of a touch operation surface 16a of the input device 16. A rear edge portion of the glass plate 30 is in close vicinity to a front edge portion 28a of the frame portion 28. The transmission window 19 is formed by a belt-like portion of the glass plate 30 interposed between the rear edge portion 16b and the front edge portion 28a in plan view.

In the glass plate 30, at least a portion forming the transmission window 19 needs to be able to transmit light of the light emitting device 18 in the thickness direction. The glass plate 30 is formed by a black translucent glass in its portion forming the transmission window 19 or in its entirety, for example. With this configuration, light emitted by the light emitting device 18 (see lights L1 to L5 in FIG. 3B) can be surely transmitted through the transmission window 19 and thus can be emitted therethrough with sufficient brightness. Further, since the transmission window 19 is formed by the black translucent glass, in the state where the light emitting device 18 is not emitting light, the transmission window 19 and the light emitting device 18 do not appear externally so that high appearance quality is ensured (see FIG. 3A). In the case of the configuration in which the glass plate 30 is not provided, the transmission window 19 may be configured by providing a dedicated glass plate or the like in a hole portion formed in the top cover member 26, for example.

The input device 16 uses a feedback technology (haptics technology) that transmits a click feeling to a user by the sense of touch without the mechanical up-and-down movement by generating a vibration with a vibration generator according to an input operation of the user. The input device 16 generates a vibration according to a click operation (press operation) on the touch operation surface 16a. The input device 16 is controlled not to generate a vibration in response to a tracing operation on the touch operation surface 16a, but alternatively it may be controlled to generate a vibration upon a tracing operation on the touch operation surface 16a. The input device 16 may be broadly referred to as a click pad without limiting the specific mechanics of how the click feeling is generated.

Next, the configuration of the light emitting device 18 will be described.

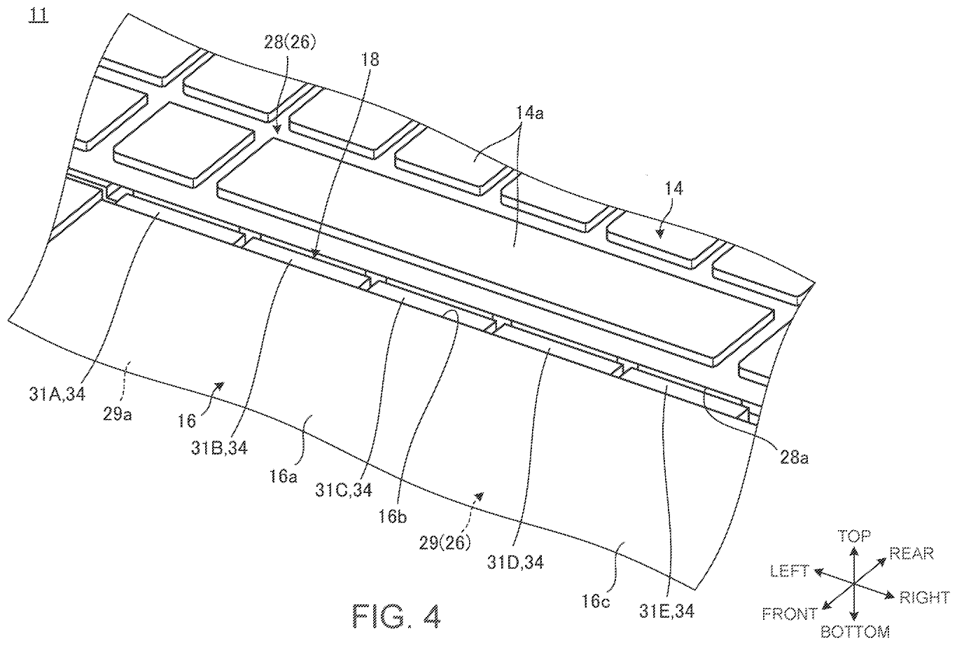

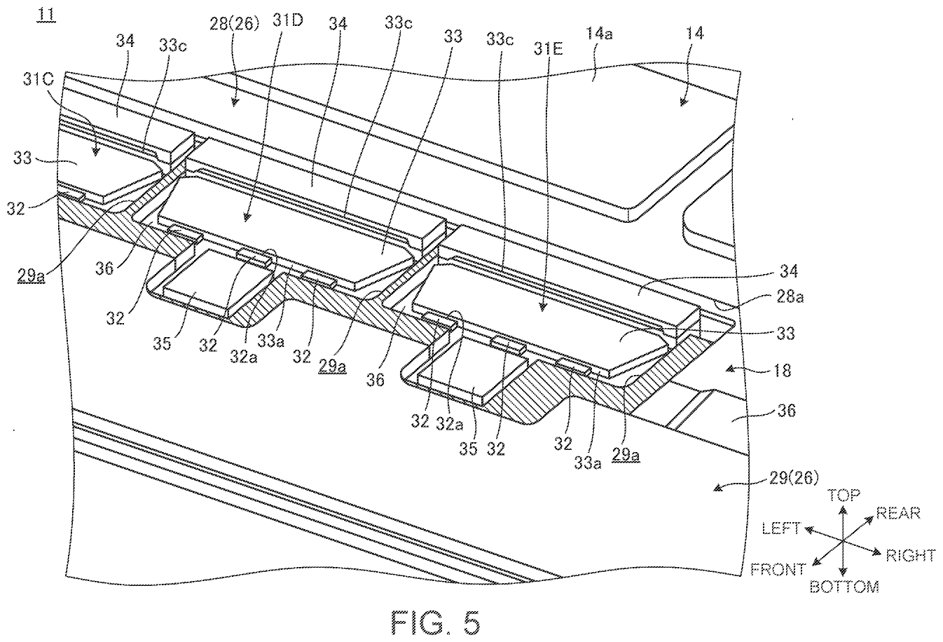

FIG. 4 is a perspective view in which the light emitting device 18 and its peripheral portion are viewed from above in the state where the transmission window 19 (the glass plate 30) is omitted. FIG. 5 is a perspective view in which the light emitting device 18 and its peripheral portion are viewed from above in the state where part of the plate portion 29 is cut by a horizontal plane along the front-rear direction and the left-right direction. FIG. 6 is an exploded perspective view in which the light emitting device 18 and its peripheral portion are viewed from below. In FIGS. 5 and 6, illustration of the input device 16 is omitted. FIG. 7 is a schematic side sectional view in which the first chassis 11 is cut by a vertical plane along the front-rear direction and the top-bottom direction at a position passing through the light emitting device 18.

The light emitting device 18 of this embodiment includes five light emitting portions 31A to 31E arranged in the left-right direction (see FIG. 4). As illustrated in FIGS. 3B and 4, by emitting lights from the light emitting portions 31A to 31E, respectively, the light emitting device 18 is able to turn on or off part or all of five belt-like lights L1 to L5 through the transmission window 19 as appropriate. That is, the light emitting portion 31A emits the light L1, the light emitting portion 31B emits the light L2, the light emitting portion 31C emits the light L3, the light emitting portion 31D emits the light L4, and the light emitting portion 31E emits the light L5.

The lights L1 to L5 are linked to an operation of a pointing stick 14b (see FIG. 1) mounted in the keyboard device 14, and a push button operation of the input device 16, for example. The pointing stick 14b functions as one of mouse devices and can operate a cursor displayed on the display 20.

In the lights L1 to L5, the four lights L1, L2, L4, L5 other than the center light L3 are simultaneously turned on when a user touches the pointing stick 14b with a fingertip, for example. The two lights L1, L2 on the left side indicate a position of a left button region of the touch operation surface 16a (corresponding to a left button in the case of a mouse). The two lights L4, L5 on the right side indicate a position of a right button region of the touch operation surface 16a (corresponding to a right button in the case of a mouse). As illustrated in FIG. 3A, the input device 16 has a simple external appearance provided with no mark or the like indicating the button regions on the touch operation surface 16a. Therefore, the electronic apparatus 10 uses the lights L1 to L5 as a guide mark indicating the positions of the button regions. The position of a center button region of the touch operation surface 16a (corresponding to a center button in the case of a mouse) can be indicated by not turning on the light L3 between the left and right lights L2, L4 or turning on the light L3 with a color different from that of the other lights L1, L2, L4, L5, for example. As illustrated in FIG. 3A, the center button region may be clearly indicated by providing some dots on the touch operation surface 16a. For example, control may be performed such that when the left button region of the touch operation surface 16a is press-operated, only the two lights L1, L2 on the left side are maintained to be turned on and the other lights L3 to L5 are turned off. The right button region and the center button region may also be controlled in the same way. With this configuration, the button region being operated by a user can also be easily recognized. Naturally, control and use of the lights L1 to L5 can be changed as appropriate.

Next, the specific configurations of the light emitting portions 31A to 31E will be described.

As illustrated in FIGS. 4 to 7, the light emitting portions 31A to 31E are arranged in a direction perpendicular to an emission direction (rearward) of lights from light emitting chips 32, i.e. are arranged side by side in the left-right direction. Each of the light emitting portions 31A to 31E is formed in an approximately L-shape in side view, extends from the front to the rear under the input device 16, and then stands upright. The basic configurations of the light emitting portions 31A to 31E may be the same or similar. Therefore, hereinafter, constituent elements of the light emitting portions 31A to 31E will be collectively described by giving the same reference symbols thereto.

As illustrated in FIGS. 4 to 7, each of the light emitting portions 31A to 31E includes the plurality of light emitting chips 32, a single light guide member 33, a single light diffusion member 34, and a single controller 35. The light emitting device 18 of this embodiment is configured such that the light emitting chips 32 and the controllers 35 of all the light emitting portions 31A to 31E are collectively mounted on a single flexible board 36, and that the light guide members 33 and the light diffusion members of all the light emitting portions 31A to 31E are supported on the flexible board 36 (see FIGS. 5 and 6). That is, the light emitting device 18 has a modular structure in which the light emitting portions 31A to 31E are integrated together so that the operation of attaching the light emitting device 18 to the first chassis 11 is efficient with the minimum number of parts. The light emitting device 18 may alternatively be configured such that the light emitting portions 31A to 31E are mounted on individual flexible boards, respectively, or that part of the light emitting portions 31A to 31E are mounted on a common flexible board.

As illustrated in FIGS. 5 to 7, the three light emitting chips 32 are used in a set in each of the light emitting portions 31A to 31E. The light emitting chips 32 in the set are arranged at regular intervals in the left-right direction. In this embodiment, by arranging the set of the three light emitting chips 32 for the single light guide member 33, the brightness of light emitted from the single light diffusion member 34 is enhanced. The arrangement number of the light emitting chips 32 in each of the light emitting portions 31A to 31E may be other than three, and the arrangement intervals between them may be unequal.

Each of the light emitting chips 32 is, for example, an RGB light emitting diode (LED) that can emit light in white, red, yellow, orange, blue, or the like. Each of the light emitting chips 32 has a side surface facing rearward that serves as a light emitting surface 32a and emits light rearward. The light emitting chips 32 of the light emitting portions 31A to 31E are mounted on a top surface of the flexible board 36.

As illustrated in FIGS. 5 to 7, the light guide member 33 is a transparent plate disposed along the touch operation surface 16a and is formed in an approximately trapezoidal shape in plan view gradually increasing in width toward the rear. The light guide member 33 is made of transparent acrylic resin, for example. In the state where the light guide member 33 is integrated with the light diffusion member 34 by bonding or the like, the light guide member 33 is inserted into a recessed portion 41 of the top cover member 26, which will be described later, and covered with the flexible board 36. The light guide member 33 receives lights from the set of the three light emitting chips 32 on a light receiving surface 33a, guides the lights and mixes colors thereof along the front-rear direction, and emits the lights from emission surfaces 33b, 33c to the light diffusion member 34. The light guide member 33 is covered with a light reflecting member 38 at a portion other than the light receiving surface 33a and the emission surfaces 33b, 33c.

The light receiving surface 33a is a front side surface of the light guide member 33 and faces the light emitting surfaces 32a of the light emitting chips 32. The light emitting chips 32 are disposed in the state where the light emitting surfaces 32a are in contact with or in close vicinity to the light receiving surface 33a of the light guide member 33.

The emission surface 33b is a rear side surface of the light guide member 33. The emission surface 33c is a rear top surface of the light guide member 33. In this embodiment, a cutout portion 34a is formed in a front bottom corner of the light diffusion member 34 (see FIG. 7). A rear portion of the light guide member 33 is inserted into the cutout portion 34a so that two surfaces of the rear portion of the light guide member 33 serve as the emission surfaces 33b, 33c. The light diffusion member 34 may be configured not to have the cutout portion 34a. In this case, the light guide member 33 may be configured such that, for example, a rear side surface of the light guide member 33 is abutted against a front side surface of the light diffusion member 34 to allow only the rear side surface of the light guide member 33 to function as the emission surface 33b.

The light reflecting member 38 is a reflecting plate that covers the outer surfaces of the light guide member 33 to restrain light passing through the inside of the light guide member 33 from leaking to the outside of the light guide member 33, thereby improving the light guide efficiency. The light reflecting member 38 is provided so as to cover the outer surfaces of the light guide member 33 at a portion other than the emission surfaces 33b, 33c and other than portions of the light receiving surface 33a respectively facing the light emitting chips 32.

As illustrated in FIGS. 5 to 7, the light diffusion member 34 is a translucent plate that stands upright along the thickness direction (the top-bottom direction) of the first chassis 11 and the input device 16. The light diffusion member 34 is made of milky white translucent resin, for example. The light diffusion member has a width in the left-right direction that is approximately equal to a width of the emission surface 33b of the light guide member 33 in the left-right direction. The light diffusion member 34 is fixed to the top surface of the flexible board 36 in the state where the rear portion of the light guide member 33 is inserted into the bottom cutout portion 34a. The light diffusion member 34 is a member configured to diffuse lights having passed through the emission surfaces 33b, 33c of the light guide member 33 and guide them to the transmission window 19.

The light diffusion member 34 is disposed in a gap portion G formed between the rear edge portion 16b of the input device 16 and the front edge portion 28a of the frame portion 28 (a front edge portion of the keyboard device 14) in the front-rear direction. The light diffusion member is disposed at a position interposed between the transmission window 19 (the glass plate 30) and the flexible board 36 in the top-bottom direction.

The light diffusion member 34 faces the emission surfaces 33b, 33c of the light guide member 33 at its bottom portion (the inner surfaces of the cutout portion 34a). A top portion (top surface) of the light diffusion member 34 serves as an emission surface 34b that faces a bottom surface of the transmission window 19. With this configuration, the light diffusion members 34 diffuse lights emitted from the light guide members 33, guide them upward, and produce lights L1 to L5 that are emitted to the outside of the first chassis 11 through the transmission window 19, specifically, that are emitted upward from the surface 11a.

As illustrated in FIGS. 5 to 7, the controller 35 is a control chip configured to control the light emission of the light emitting chips 32. The controller 35 is mounted on the top surface of the flexible board 36. The controller 35 is disposed on the front side of the center light emitting chip 32 of the set of the three light emitting chips 32.

As illustrated in FIGS. 5 to 7, the flexible board 36 is mounted with the light emitting chips 32 and the controllers 35 of all the light emitting portions 31A to 31E. The flexible board 36 is a flexible printed circuit (FPC) formed thin and flexible by using an insulating film with flexibility, for example. The flexible board 36 is wiring that connects the mounted light emitting chips 32 and controllers 35 to the motherboard installed in the first chassis 11. The flexible board 36 of this embodiment is connected to an input detection board 16c of the input device 16 so as to be connected to the motherboard via the board 16c. The flexible board 36 may alternatively be connected directly to the motherboard.

As illustrated in FIG. 7, a reinforcing plate 40 is stacked on a bottom surface of the flexible board 36. The reinforcing plate 40 is a thin plate that is slightly thicker than the flexible board 36 and made of metal or resin. The reinforcing plate 40 is a member for reinforcing the strength of the flexible board 36. When, for example, the strength of the flexible board 36 can be sufficiently ensured, the reinforcing plate 40 may be omitted.

Next, the attaching structure of the light emitting device 18 to the first chassis 11 will be described.

As described above, the light emitting device 18 has the modular structure in which the five light emitting portions 31A to 31E are integrated together by the flexible board 36. The light emitting device 18 is attached from below to the plate portion 29 of the top cover member 26 of the first chassis 11 (see FIGS. 6 and 7).

As illustrated in FIGS. 5 to 7, the plate portion 29 is formed with five recessed portions 41 facing downward and arranged side by side in the left-right direction and five top-bottom vertical holes 41a arranged side by side in the left-right direction. Each of the recessed portions 41 is a recessed portion in the form of a shallow bathtub that is formed by recessing a bottom surface of the plate portion 29 upward. The controller 35, the light emitting chips 32, and the light guide member 33 of each of the light emitting portions 31A to 31E are housed in a corresponding one of the recessed portions 41. That is, each of the recessed portions 41 has a depth and a shape that can house the controller 35, light emitting chips 32, and light guide member 33. The vertical hole 41a penetrates a rear portion of a top surface 41b of each of the recessed portions 41. The light diffusion member 34 is disposed in the gap portion G in such a way that only a bottom portion thereof is disposed in the recessed portion 41 and that a top portion thereof passes through the vertical hole 41a.

The inside of the recessed portion 41 is surrounded by the top surface 41b and four peripheral side walls 41c except for the vertical hole 41a and a bottom surface opening. The boundary between the adjacent recessed portions 41 is also partitioned by the side wall 41c (see FIGS. 5 and 6).

Fixing surfaces 41d formed slightly higher than the other portions of the bottom surface of the plate portion 29 are provided at the opening edge portions of the recessed portions 41. The top surface of the flexible board 36 is fixed to the fixing surfaces 41d by an adhesive member 42 (see FIG. 7). The adhesive member 42 is an adhesive or a double-sided tape. The flexible board 36 is fixed to the fixing surfaces 41d so as to close the bottom surface openings of the respective recessed portions 41, thereby collectively closing the bottom surface openings of all the recessed portions 41. With this configuration, the light emitting chips 32, the light guide members 33, and the light diffusion members 34 of the light emitting portions 31A to 31E are confined in the recessed portions 41 closed by the flexible board 36 and thus are shielded from the surroundings. That is, the light emitting chips 32 and the light guide member 33 of each of the light emitting portions 31A to 31E housed in the corresponding recessed portion 41 are isolated from the light emitting chips 32 and the light guide member 33 of the other of the light emitting portions 31A to 31E housed in the adjacent recessed portion 41. As a result, light leakage between the adjacent light emitting portions 31A to 31E is prevented. The light emitting device 18 is attached to the first chassis 11 as described above.

On the other hand, the input device 16 is attached from above to the plate portion 29. Specifically, in the state where the input device 16 is fixed to a bottom surface of the glass plate 30 by an adhesive member 43 as illustrated in FIG. 7, the input device 16 is fixed to the top surface (the surface 11a) of the plate portion 29 along with the glass plate 30. The adhesive member 43 is an adhesive or a double-sided tape. Reference symbol 44 in FIG. 7 denotes a spacer member such as a sponge provided between a bottom surface of the input device 16 and the top surface of the plate portion 29. That is, the plate portion 29 supports the input device 16 and the light emitting device 18 and is interposed between the input device 16 and the light emitting device 18.

Reference symbol 14c in FIG. 7 denotes a base portion of the keyboard device 14. The base portion 14c is a laminate of a switch sheet (membrane sheet), a base plate, a light guide plate, a waterproof sheet, and so on. The keyboard device 14 is fitted from below to the frame portion 28, and then the base portion 14c is fixed to the frame portion 28 by screws or the like so that the keyboard device 14 is fixed to the first chassis 11. The key tops 14a are supported on the base plate of the base portion 14c via a scissor mechanism or a rubber dome so as to be movable up and down.

Next, the operations and the actions and effects of the light emitting device 18 will be described.

In the light emitting device 18, when, for example, turning on only the center light emitting portion 31C, lights emitted rearward from the light emitting surfaces 32a of the three light emitting chips 32 of the light emitting portion 31C are first introduced into the light guide member 33 through the light receiving surface 33a (see FIG. 7). Arrows in dash-dot line indicated in FIG. 7 schematically illustrate the trajectory of light emitted from the light emitting chip 32. The lights introduced into the light guide member 33 are guided toward the rear while being reflected by the surrounding light reflecting member 38. The lights guided in the light guide member 33 pass through the emission surfaces 33b, 33c and then are diffused in the light diffusion member 34 and transmitted through the transmission window 19 so as to be emitted as light L3 from the surface 11a of the first chassis 11. The light emitting operations of the other light emitting portions 31A, 31B, 31D, 31E are performed in the same way.

In this event, the boundaries between the center light emitting portion 31C performing the light emitting operation and the light emitting portions 31B, 31D adjacent to the light emitting portion 31C are partitioned by the side walls 41c of the recessed portions 41. Therefore, lights emitted from the light emitting chips 32 of the light emitting portion 31C are prevented from being introduced into the light guide members 33 of the adjacent other light emitting portions 31B, 31D so that it is possible to surely turn on only the desired light L3.

As described above, the electronic apparatus 10 according to this embodiment includes: the input device 16 configured such that the touch operation surface 16a configured to accept a touch operation is provided to face the surface 11a of the first chassis 11; and the light emitting device 18 including the light emitting portions 31A to 31E configured to emit lights toward the transmission window 19 provided to the surface 11a of the first chassis 11. In each of the light emitting portions 31A to 31E, the light emitting chips 32 are disposed under the input device 16, and the light guide member 33 extends along the touch operation surface 16a under the input device 16. The light diffusion member 34 is disposed upright in the top-bottom direction on the side of the input device 16 so as to emit light from the emission surface 34b at its top portion to the transmission window 19.

In a light emitting device with a general configuration, it is conceivable that the light emitting chip 32, the light guide member 33, and the light diffusion member 34 are arranged next to one another in the top-bottom direction for emitting light upward from the surface 11a of the first chassis 11. Consequently, the thickness of the light emitting device in the top-bottom direction increases to impede a reduction in thickness of the first chassis 11.

In this regard, in the light emitting device 18, the light emitting chip 32 and the light guide member 33 are arranged next to each other in the front-rear direction under the input device 16, and only the light diffusion member 34 is made upright in the top-bottom direction on the side of the input device 16. With this configuration, while minimizing the thickness in the top-bottom direction, the light emitting device 18 can emit lights L1 to L5 with sufficient brightness and visibility to the transmission window 19 provided to the surface 11a of the first chassis 11. In particular, the light guide member 33 serving as a color mixing region of lights emitted from the light emitting chips 32 needs to be able to guide the lights over a somewhat long distance for improving the light uniformity. Therefore, the light guide member 33 of this embodiment is placed horizontally to achieve both a sufficient light guide distance and a reduction in thickness. As a result, with the electronic apparatus 10, it is possible to achieve light emission with sufficient brightness by the light emitting device 18 and a reduction in thickness of the first chassis 11.

Further, in the electronic apparatus 10, the light emitting chips 32 and the light guide members 33 are disposed by effectively using a dead space between the input device 16 and the battery device 17. That is, as illustrated in FIG. 7, the thickness of the input device 16 is considerably less than the thickness of the keyboard device 14. Therefore, when the light emitting device 18 is not present under the input device 16, the dead space is formed between the battery device 17 extending from under the input device 16 to under the keyboard device 14 and the bottom surface of the input device 16. Consequently, the light emitting device 18 having the L-shaped side shape is disposed in this dead space so that the electronic apparatus 10 makes it possible to turn on lights L1 to L5 with high brightness while ensuring a reduction in thickness of the first chassis 11.

In the light emitting device 18, the light diffusion members 34 are disposed on the side of the rear edge portion 16b of the input device 16. Consequently, since the emission of lights L1 to L5 occurs between the pointing stick 14b and the input device 16 that are linked to the lights L1 to L5, the visibility and operability by a user are high. As illustrated in FIGS. 1 and 2, for improving the appearance quality, the first chassis 11 has a tapered shape in which the front end portion is thinner than the rear end portion. Therefore, there are advantages that when the light diffusion member 34 is disposed on the rear side of the rear edge portion 16b of the input device 16, the diffusion distance in the top-bottom direction is ensured more easily than when the light diffusion member 34 is disposed on the front side of a front edge portion of the input device 16.

As illustrated in FIG. 7, in this embodiment, the thickness from a top surface of the glass plate 30 to a bottom surface (the reinforcing plate 40) of the light emitting device 18 is approximately equal to the thickness of the keyboard device 14. Therefore, the battery device 17 can be easily disposed to extend from under the light emitting device 18 to under the keyboard device 14 so that an increase in capacity of the battery device 17 is easy to achieve.

In a general configuration, a certain amount of space (the gap portion G) is formed at the boundary between the input device 16 and the keyboard device 14. Therefore, in the electronic apparatus 10, the transmission window 19 is disposed at the position interposed between the input device 16 and the keyboard device 14, and the light diffusion member 34 is disposed in the gap portion G between the input device 16 and the keyboard device 14. Consequently, in the electronic apparatus 10, it is also possible to restrain the light emitting device 18 from affecting the dimension of the first chassis 11 in the front-rear direction.

In the electronic apparatus 10, the glass plate 30 laid at the surface 11a of the first chassis 11 is also used as the transmission window 19. Therefore, the transmission window 19 does not stand out at the surface 11a so that high appearance quality is obtained.

It is apparent that the present disclosure is not limited to the embodiment described above and can be freely changed within the scope not departing from the spirit of the present disclosure.

The light emitting device 18 having the configuration in which the five light emitting portions 31A to 31E are arranged side by side has been described by way of example. However, the arrangement number of the light emitting portions 31A to 31E and the arrangement thereof can be changed as appropriate. Further, the transmission window (the light diffusion member 34) may be disposed, for example, forward or sideward of the input device 16, other than rearward of the input device 16.

1. A laptop computer, comprising:
a chassis including a keyboard surface having a keyboard disposed thereon and a screen surface have a screen disposed thereon;
a click pad mounted on the keyboard surface, the click pad including a touch operation surface configured to accept a touch operation; and
a light emitting device mounted in the chassis, the light emitting device being configured to emit light toward a transmission window on the keyboard surface adjacent to the click pad,
wherein the light emitting device includes:
a light emitter under the click pad,
a light guide extending along the touch operation surface under the click pad and configured to guide light from the light emitter, and
a light diffusion member adjacent to the click pad under the transmission window, the light diffusion member including a bottom portion facing an emission surface of the light guide member and a top portion facing the transmission window, the light diffusion member being configured to diffuse light emitted from the emission surface, guide the diffused light in a direction of the transmission window, and emit the diffused light to an outside of the chassis through the transmission window.

2. An electronic apparatus comprising:
a chassis;
an input device on the chassis and having a touch operation surface that is configured to accept a touch operation and configured to face a surface of the chassis; and
a light emitting device on the chassis and including a light emitting portion configured to emit light toward a transmission window at a the surface of the chassis,
wherein the light emitting portion includes:
a light emitting chip under the input device;
a light guide member extending along the touch operation surface under the input device and configured to guide light from the light emitting chip; and
a light diffusion member disposed on a side of the input device and having a bottom portion facing an emission surface of the light guide member and a top portion facing the transmission window, the light diffusion member configured to diffuse light emitted from the emission surface, guide the light toward the transmission window, and emit the light to an outside of the chassis through the transmission window.

3. The electronic apparatus according to claim 2, further comprising a glass plate covering a part of the surface of the chassis,
wherein the transmission window is a part of the glass plate.

4. The electronic apparatus according to claim 2, further comprising a keyboard device on the chassis and including a plurality of key tops exposed on the surface of the chassis,
wherein:
the transmission window is at a position between the input device and the keyboard device; and
the light diffusion member is in a gap portion between the input device and the keyboard device.

5. The electronic apparatus according to claim 4, further comprising a battery device on the chassis and disposed to extend from under the light emitting device to under the keyboard device in a direction along the touch operation surface.

6. The electronic apparatus according to claim 2, wherein:
the chassis further includes a cover member supporting the input device and the light emitting device, the cover member including a plate portion having a recessed portion, the plate portion disposed between the input device and the light emitting device;
the light emitting device further includes a flexible board mounted with the light emitting chip; and
the light emitting device is configured so that the light emitting chip and the light guide member are housed in the recessed portion and that the flexible board closes an opening of the recessed portion.

7. The electronic apparatus according to claim 6, wherein:
the light emitting device includes a plurality of the light emitting portions arranged side by side in a direction perpendicular to an emission direction of light from a plurality of the light emitting chips;
a plurality of the recessed portions is side by side to house the light emitting chips and the light guide members of the light emitting portions, respectively, and the recessed portions adjacent to each other are partitioned by a side wall; and
the flexible board is mounted with the light emitting chips of the plurality of light emitting portions and collectively closes the plurality of recessed portions.
